(19) United States
(12) Patent Application Publication
(10) Pub. No.: US 2020/0055370 A1
(43) Pub. Date: Feb. 20, 2020

(54) CONTROL DEVICE, VEHICULAR AIR CONDITIONING SYSTEM, METHOD FOR CONTROLLING VEHICULAR AIR CONDITIONING SYSTEM, AND PROGRAM

(71) Applicant: MITSUBISHI HEAVY INDUSTRIES THERMAL SYSTEMS, LTD., Tokyo (JP)

(72) Inventors: Yasuo KATAYAMA, Kiyosu-shi (JP); Nobuya NAKAGAWA, Kiyosu-shi (JP); Tomoki HASE, Tokyo (JP)

(73) Assignee: MITSUBISHI HEAVY INDUSTRIES THERMAL SYSTEMS, LTD., Tokyo (JP)

(21) Appl. No.: 16/609,368

(22) PCT Filed: Apr. 16, 2018
(86) PCT No.: PCT/JP2018/015773

§ 371 Date: Oct. 29, 2019

(30) Foreign Application Priority Data
May 15, 2017 (JP) 2017-096638

(51) Int. Cl. B60H 1/00; B60W 10/30

(52) U.S. Cl. CPC B60H 1/00785; B60W 2520/28; B60H 2001/00961; B60W 10/30

(57) ABSTRACT

A control device controlling a vehicular air conditioning system includes a defrosting operation control unit performing a defrosting operation in a refrigerant system when an outflow refrigerant temperature of an outdoor heat exchanger has become equal to or lower than a defrosting condition threshold value, a defrosting operation release instruction unit outputting a defrosting operation release instruction when the outflow refrigerant temperature has become equal to or higher than a defrosting release condition threshold value, and a vehicle information acquisition unit acquiring at least one of a position and a speed of a vehicle in which the vehicular air conditioning system is mounted. The defrosting operation release instruction unit outputs a defrosting operation release instruction even when the outflow refrigerant temperature is lower than the defrosting release condition threshold value in a case at least one of the position and the speed of the vehicle satisfies a predefined condition.

### TECHNICAL FIELD

The present invention relates to a control device, a vehicular air conditioning system, a method for controlling a vehicular air conditioning system, and a program.

Priority is claimed on Japanese Patent Application No. 2017-096638, filed on May 15, 2017, the content of which is incorporated herein by reference.

### BACKGROUND ART

It is known that when a heating operation is performed in a general air conditioning system (a heat pump system), an outdoor heat exchanger functioning as an evaporator is frosted and the heat absorption capability is degraded in a case in which an outside air temperature is low. The air conditioning system performs a defrosting operation for the purpose of removing the frost. In this defrosting operation, for example, a high-temperature high-pressure refrigerant discharged from a compressor is circulated through the outdoor heat exchanger. The frost formed on a surface of the outdoor heat exchanger is melted by the heat of the high-temperature high-pressure refrigerant.

### CITATION LIST

### Patent Literature

### [Patent Literature 1] Japanese Unexamined Patent Application, First Publication No. 2012-162149

### SUMMARY OF INVENTION

### Technical Problem

In a vehicular air conditioning system, it is assumed that a vehicle is traveling during a defrosting operation. When the vehicle is traveling during the defrosting operation, an outdoor heat exchanger is exposed to wind (traveling wind), and therefore, the heat of a high-temperature high-pressure refrigerant flowing into the outdoor heat exchanger is removed by the wind. Thus, the defrosting performance is degraded, and it becomes difficult to melt the frost attached to the outdoor heat exchanger. As a result, since defrosting release conditions are not satisfied, the defrosting operation continues for a long time, a heating operation cannot be used during this time and inconvenience is caused for the occupants.

As a measure to solve the above problem, it is conceivable to provide a shutter (an air shield device) at a traveling wind inlet. However, mounting of the shutter not only increases costs, but also is likely to adversely affect other devices (a radiator or the like) that require cooling.

The present invention has been made in view of the problem, and an object of the present invention is to provide a control device capable of preventing a defrosting operation from continuing for a long time, a vehicular air conditioning system, a method for controlling a vehicular air conditioning system, and a program.

### Solution to Problem

According to a first aspect of the present invention, a control device configured to control a vehicular air conditioning system includes a defrosting operation control unit configured to perform a defrosting operation in a refrigerant system when an outflow refrigerant temperature of an outdoor heat exchanger that is one of heat exchangers in the refrigerant system and is disposed outside has become equal to or lower than a defrosting condition threshold value; a defrosting operation release instruction unit configured to output a defrosting operation release instruction when the outflow refrigerant temperature has become equal to or higher than a defrosting release condition threshold value; and a vehicle information acquisition unit configured to acquire at least one of a position and a speed of a vehicle in which the vehicular air conditioning system is mounted. The defrosting operation release instruction unit is configured to further output the defrosting operation release instruction even when the outflow refrigerant temperature is lower than the defrosting release condition threshold value in a case in which at least one of the position and the speed of the vehicle satisfies a predefined condition.

Further, according to a second aspect of the present invention, in the control device described above, the defrosting operation release instruction unit is configured to output the release instruction when a time during which the speed of the vehicle is equal to or higher than a predetermined speed determination threshold value has continued for a predetermined time or more.

Further, according to a third aspect of the present invention, in the control device described above, the defrosting operation release instruction unit is configured to output the release instruction when the vehicle enters a predefined area.

Further, according to a fourth aspect of the present invention, in the control device described above, the defrosting operation release instruction unit is configured to output the release instruction when the vehicle has entered an expressway.

Further, according to a fifth aspect of the present invention, the control device described above further includes a destination information acquisition unit configured to acquire information indicating a destination of an occupant, and the defrosting operation release instruction unit is configured to output the release instruction when a distance from the vehicle to the destination has become equal to or smaller than a predetermined determination threshold value.

Further, according to a sixth aspect of the present invention, in the control device described above, the defrosting operation control unit is configured to further perform the defrosting operation even when the outflow refrigerant temperature exceeds the defrosting condition threshold value in a case in which at least one of the position and the speed of the vehicle satisfies a predefined condition.

Further, according to a seventh aspect of the present invention, a control device configured to control a vehicular air conditioning system includes a defrosting operation control unit configured to perform a defrosting operation in a refrigerant system when an outflow refrigerant temperature of an outdoor heat exchanger that is one of heat exchangers in the refrigerant system and is disposed outside has become equal to or lower than a defrosting condition threshold value; and a vehicle information acquisition unit configured to acquire at least one of a position and a speed of a vehicle in which the vehicular air conditioning system is mounted. The defrosting operation control unit is configured to further perform the defrosting operation even when the outflow refrigerant temperature exceeds the defrosting condition threshold value in a case in which at least one of the position and the speed of the vehicle satisfies a predefined condition.

Further, according to an eighth aspect of the present invention, a vehicular air conditioning system includes the control device according to any one of the first to seventh aspects; and the refrigerant system.

Further, according to a ninth aspect of the present invention, a vehicular air conditioning system method for controlling a vehicular air conditioning system for controlling a vehicular air conditioning system includes a defrosting operation control step of performing a defrosting operation in a refrigerant system when an outflow refrigerant temperature of an outdoor heat exchanger that is one of heat exchangers in the refrigerant system and is disposed outside becomes equal to or lower than a defrosting condition threshold value; a defrosting operation release instruction step of outputting a defrosting operation release instruction when the outflow refrigerant temperature becomes equal to or higher than a defrosting release condition threshold value; and a vehicle information acquisition step of acquiring at least one of a position and a speed of a vehicle in which the vehicular air conditioning system is mounted, wherein the defrosting operation release instruction step includes a step of further outputting a defrosting operation release instruction even when the outflow refrigerant temperature is lower than the defrosting release condition threshold value in a case in which at least one of the position and the speed of the vehicle satisfies a predefined condition.

Further, according to a tenth aspect of the present invention, a program causes a computer configured to control a vehicular air conditioning system to function as: a defrosting operation control unit configured to perform a defrosting operation in a refrigerant system when an outflow refrigerant temperature of an outdoor heat exchanger that is one of heat exchangers in the refrigerant system and is disposed outside becomes equal to or lower than a defrosting condition threshold value; a defrosting operation release instruction unit configured to output a defrosting operation release instruction when the outflow refrigerant temperature becomes equal to or higher than a defrosting release condition threshold value; and a vehicle information acquisition unit configured to acquire at least one of a position and a speed of a vehicle in which the vehicular air conditioning system is mounted, wherein the defrosting operation release instruction unit is configured to further output the defrosting operation release instruction even when the outflow refrigerant temperature is lower than the defrosting release condition threshold value in a case in which at least one of the position and the speed of the vehicle satisfies a predefined condition.

### Advantageous Effects of Invention

With the control device, the vehicular air conditioning system, the method for controlling a vehicular air conditioning system, and the program described above, it is possible to prevent the defrosting operation from continuing for a long time.

### BRIEF DESCRIPTION OF DRAWINGS

FIG. 1 is a diagram illustrating an overall configuration of a vehicular air conditioning system according to a first embodiment.

FIG. 2 is a diagram illustrating a functional configuration of a control unit according to the first embodiment.

FIG. 3 is a diagram illustrating a process flow of a control unit according to the first embodiment.

FIG. 4 is a first diagram illustrating a process flow of the control unit according to the first embodiment in detail.

FIG. 5 is a second diagram illustrating the process flow of the control unit according to the first embodiment in detail.

FIG. 6 is a third diagram illustrating the process flow of the control unit according to the first embodiment in detail;

FIG. 7 is a diagram illustrating a process flow of a control unit according to a second embodiment.

### DESCRIPTION OF EMBODIMENTS

### First Embodiment

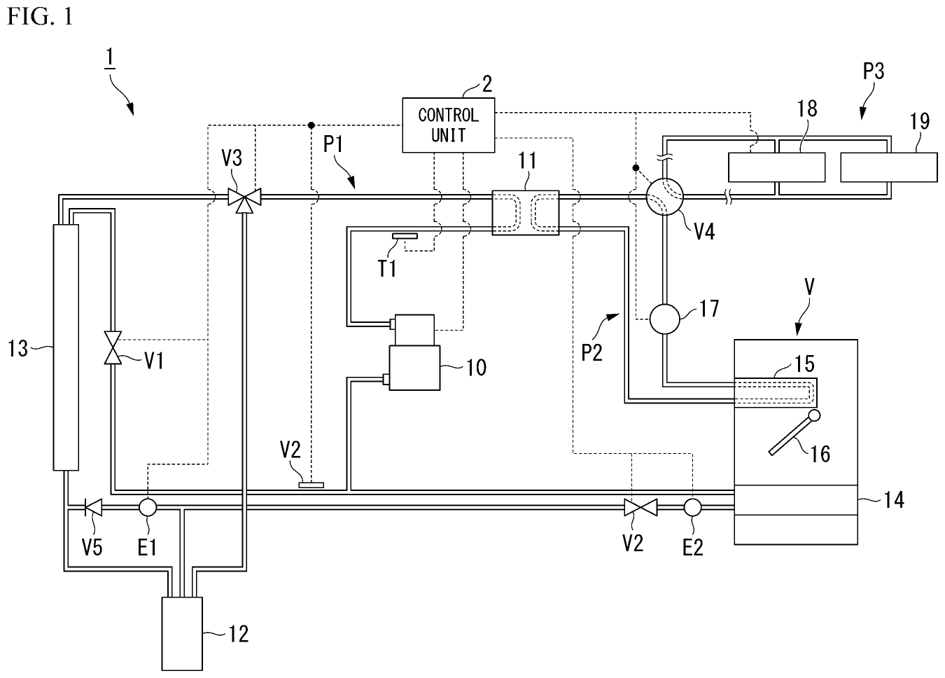

Hereinafter, a vehicular air conditioning system according to a first embodiment will be described with reference to FIGS. 1 to 4.

### (Overall Configuration of Vehicular Air Conditioning System)

FIG. 1 is a diagram illustrating an overall configuration of the vehicular air conditioning system according to the first embodiment.

The vehicular air conditioning system 1 illustrated in FIG. 1 is, for example, an air conditioning system mounted on a hybrid vehicle in which a storage battery and an engine are mounted.

As illustrated in FIG. 1, the vehicular air conditioning system 1 includes a refrigerant system P1 through which a refrigerant circulates, a hot water system P2 through which hot water for generating hot air for a vehicle cabin circulates, and an engine coolant system P3 through which coolant for cooling the engine 18 circulates.

A compressor 10, a water/refrigerant heat exchanger 11, a receiver 12, an outdoor heat exchanger 13, an evaporator 14, and expansion valves E1 and E2 are provided in the refrigerant system P1.

The compressor 10 sucks and compresses a high-temperature low-pressure refrigerant obtained through the outdoor heat exchanger 13 or the evaporator 14 and discharges a high-temperature high-pressure refrigerant.

The water/refrigerant heat exchanger 11 is one of heat exchangers in the refrigerant system P1, and is disposed over the refrigerant system P1 and the hot water system P2. The water/refrigerant heat exchanger 11 exchanges heat between the refrigerant circulating through the refrigerant system P1 and the hot water circulating through the hot water system P2.

The receiver 12 performs gas-liquid separation of the refrigerant condensed by the water/refrigerant heat exchanger 11 or the outdoor heat exchanger 13, and sends only the liquid refrigerant to the expansion valve E1 or the expansion valve E2.

The outdoor heat exchanger 13 is one of the heat exchangers in the refrigerant system P1, and is a heat exchanger disposed outside the vehicle.

The evaporator 14 is one of the heat exchangers in the refrigerant system P1, and is a heat exchanger disposed inside the vehicle (inside an indoor unit U).

The expansion valve E1 decompresses the low-temperature high-pressure refrigerant condensed through the water/refrigerant heat exchanger 11 and sends the refrigerant to the outdoor heat exchanger 13 during the heating operation. Further, the expansion valve E2 decompresses the refrigerant condensed through the outdoor heat exchanger 13 and sends the refrigerant to the evaporator 14 during the defrosting operation.

The refrigerant system P1 further includes two-way electromagnetic valves V1 and V2, a three-way electromagnetic valve V3, a check valve V5, and refrigerant temperature sensors T1 and T2.

The two-way electromagnetic valves V1 and V2, the three-way electromagnetic valve V3, and the check valve V5 are electromagnetic valves that are used to switch between a refrigerant circulation path in a heating operation and a refrigerant circulation path in a defrosting operation.

The refrigerant temperature sensor T1 is a temperature sensor provided in a pipe that connects a refrigerant inlet of the water/refrigerant heat exchanger 11 from the discharge side of the compressor 10. A refrigerant temperature sensor T2 is a temperature sensor provided in a pipe that connects the suction side of the compressor 10 from a refrigerant outlet of the outdoor heat exchanger 13.

The refrigerant system P1 constitutes a generally well-known heat pump system. That is, in a heating operation, the refrigerant circulates around the refrigerant system P1 in an order of the compressor 10, the water/refrigerant heat exchanger 11, the receiver 12, the expansion valve E1, and the outdoor heat exchanger 13, such that heat absorbed by the outdoor heat exchanger 13 is dissipated by the water/refrigerant heat exchanger 11. In this case, the outdoor heat exchanger 13 functions as an evaporator, and the water/refrigerant heat exchanger 11 functions as a condenser. Accordingly, the hot water circulating through the hot water system P2 via the water/refrigerant heat exchanger 11 is heated.

Further, when the outside air temperature is low, the outdoor heat exchanger 13 may become frosted in the heating operation. In this case, the defrosting operation is performed for the purpose of removing (melting) this frost. In the defrosting operation, the refrigerant circulates around the refrigerant system P1 in an order of the compressor 10, the water/refrigerant heat exchanger 11, the outdoor heat exchanger 13, the receiver 12, the expansion valve E2, and the evaporator 14, so that the heat absorbed by the evaporator 14 is dissipated by the outdoor heat exchanger 13. In this case, the outdoor heat exchanger 13 functions as a condenser. Accordingly, the outdoor heat exchanger 13 is heated and the frost is melted.

Further, the refrigerant circulation path in the normal cooling operation is the same as that in the defrosting operation described above. The refrigerant circulates as in the defrosting operation, such that the heat in the vehicle cabin is absorbed through the evaporator 14 and the vehicle cabin is cooled.

A water pump 17, a heater 15, and a water/refrigerant heat exchanger 11 are provided in the hot water system P2.

The water pump 17 circulates hot water in the hot water system P2. The hot water circulated by the water pump 17 absorbs heat of refrigerant circulating through the refrigerant system P1, through the water/refrigerant heat exchanger 11, and is heated.

The heater 15 functions as a heat source through circulation of hot water heated through the water/refrigerant heat exchanger 11. The heater 15 is disposed inside the indoor unit U that forms a flow path for circulating air in the vehicle cabin.

The engine 18 that is a cooling target and a radiator 19 are provided in the engine coolant system P3.

The engine 18 is activated when the engine 18 is required as a power source of a vehicle (for example, when a capacity of a storage battery has decreased in a hybrid vehicle). As the engine 18 is driven (rotated), the engine 18 becomes a heat source, and a coolant circulating through the engine coolant system P3 is heated.

The radiator 19 exposes the heated coolant to the outside air, dissipates heat, and cools the heated coolant.

Further, a four-way valve V4 capable of switching between connection and disconnection of pipes of the engine coolant system P3 and the hot water system P2 is provided between the engine coolant system P3 and the hot water system P2. When the hot water system P2 and the engine coolant system P3 are connected by the four-way valve V4, the coolant circulating through the engine coolant system P3 circulates through the water/refrigerant heat exchanger 11 and the heater 15 provided in the hot water system P2.

The indoor unit U is a unit that generates hot air (cold air) according to the heating operation (cooling operation) and sends the hot air (the cold air) into the vehicle cabin through a vent. As illustrated in FIG. 1, the evaporator 14, the heater 15, an air mix damper 16, and a blower B are disposed in the indoor unit U.

The blower B performs blowing into the vehicle cabin. In the case of the heating operation, the air (hot air) warmed by the heater 15 is blown into the vehicle cabin by the blower B. In this case, a blowing temperature is adjusted according to a degree of opening of the air mix damper 16. Further, in the case of the cooling operation, the air (cold air) cooled by the evaporator 14 is blown into the vehicle cabin by the blower B.

A control unit 2 is a control device that controls an overall operation of the vehicular air conditioning system 1. That is, the control unit 2 controls the compressor 10, the water pump 17, the expansion valves E1 and E2, various electromagnetic valves (the two-way electromagnetic valves V1 and V2, the three-way electromagnetic valve V3, and the four-way valve V4), the air mix damper 16, and the like such that the heating operation or the cooling operation is performed according to a manipulation of the occupant of the vehicle. In this case, the control unit 2 monitors a refrigerant temperature at each place through the refrigerant temperature sensors T1 and T2. Further, the control unit 2 drives the engine 18, as necessary.

The control unit 2 performs the defrosting operation when the predetermined condition has been satisfied. Details of the function of the control unit 2 related to the defrosting operation will be described below.

### (Functional Configuration of Control Unit)

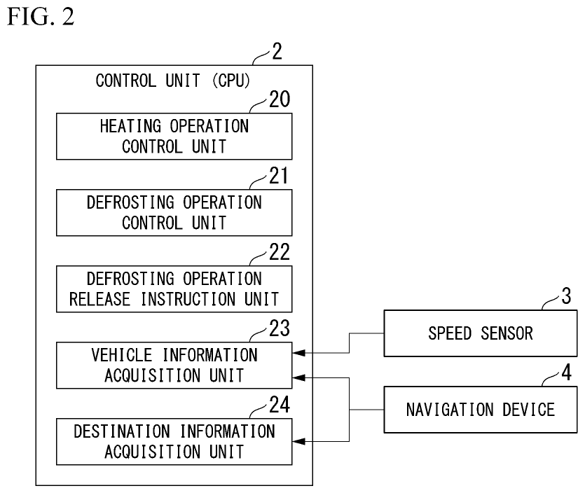

FIG. 2 is a diagram illustrating a functional configuration of the control unit according to the first embodiment.

The control unit 2 illustrated in FIG. 2 is, for example, a CPU (microcomputer), and controls an overall operation of the vehicular air conditioning system 1. The control unit 2 operates according to a program prepared in advance to exhibit functions of a heating operation control unit 20, a defrosting operation control unit 21, a defrosting operation release instruction unit 22, a vehicle information acquisition unit 23, and a destination information acquisition unit 24.

Further, a speed sensor 3 is a speed sensor of a vehicle in which the vehicular air conditioning system 1 is mounted, and detects a traveling speed of the vehicle.

Further, a navigation device 4 is a general car navigation device. Specifically, the navigation device 4 acquires position information (information indicating latitude and longitude) on the basis of radio waves received from satellites of a global navigation satellite system (GNSS), for example. The navigation device 4 performs guidance for a traveling route while presenting the position of the vehicle to an occupant on the basis of the acquired position information.

When a manipulation of a request for a heating operation is performed by the occupant, the heating operation control unit 20 controls the compressor 10 and various valves (the expansion valves E1 and E2, the two-way electromagnetic valves V1 and V2, the three-way electromagnetic valve V3, and the like) provided in the refrigerant system P1 such that a heating operation is performed.

The defrosting operation control unit 21 controls the compressor 10 and various valves provided in the refrigerant system P1 such that a defrosting operation is performed when the outflow refrigerant temperature of the outdoor heat exchanger 13 has become equal to or lower than the defrosting condition threshold value during the heating operation. Here, the “outflow refrigerant temperature of the outdoor heat exchanger 13” is a temperature of the refrigerant flowing out from the outdoor heat exchanger 13, and specifically, is a temperature that is detected through the refrigerant temperature sensor T2.

The defrosting operation release instruction unit 22 outputs a defrosting operation release instruction to the defrosting operation control unit 21 when an outflow refrigerant temperature has become equal to or higher than a defrosting release condition threshold value. The defrosting operation control unit 21 releases (ends) the defrosting operation by receiving the release instruction.

The vehicle information acquisition unit 23 acquires information (vehicle information) indicating the position and speed of the vehicle in which the vehicular air conditioning system 1 is mounted. Specifically, the vehicle information acquisition unit 23 acquires information indicating the speed of the vehicle through the speed sensor 3 mounted in the vehicle. Further, the vehicle information acquisition unit 23 acquires information indicating the position of the vehicle through the navigation device 4 mounted in the vehicle.

The destination information acquisition unit 24 acquires information indicating a destination of the occupant. Specifically, the destination information acquisition unit 24 accesses the navigation device 4 and acquires position (latitude and longitude) information indicating the destination set in the navigation device 4 by the occupant.

Further, although not illustrated, the control unit 2 further includes a cooling operation control unit that controls the compressor 10 and various valves provided in the refrigerant system P1 such that the cooling operation is performed when a manipulation of a request for the cooling operation is performed by the occupant.

### (Process Flow of Control Unit)

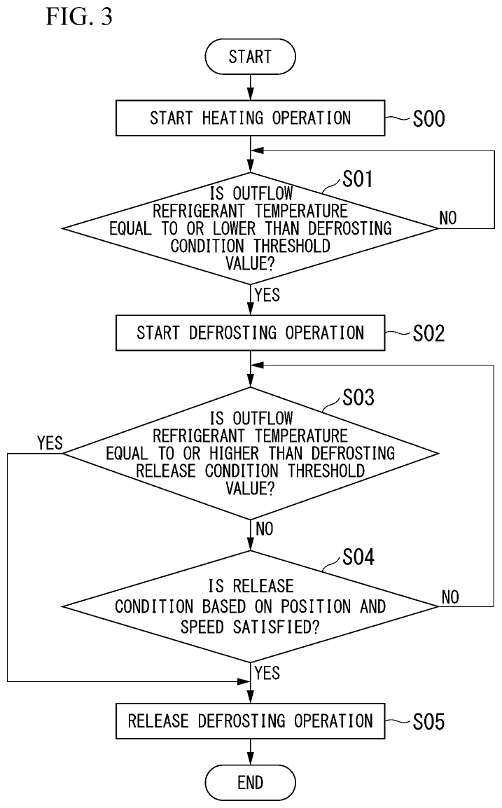

FIG. 3 is a diagram illustrating a process flow of the control unit according to the first embodiment.

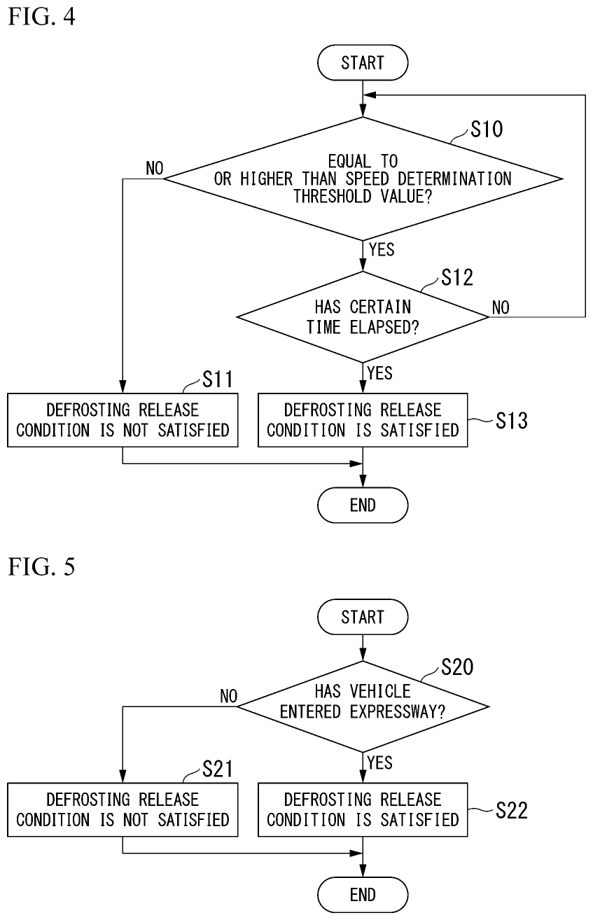

Further, FIGS. 4 to 6 are first to third diagrams illustrating the process flow of the control unit according to the first embodiment in detail, respectively.

The process flow of the control unit 2 according to the first embodiment will be described below with reference to FIGS. 3 and 4 to 6.

In the embodiment, the process flow illustrated in FIG. 3 is started from a point in time at which a manipulation for a request of the heating operation has been performed by the occupant of the vehicle.

When a manipulation for a request of the heating operation has been performed by the occupant, the heating operation control unit 20 of the control unit 2 starts the heating operation, as illustrated in FIG. 3 (step S00).

When the heating operation is started, the heating operation control unit 20 opens the two-way electromagnetic valve V1 and closes the two-way electromagnetic valve V2. Further, the heating operation control unit 20 switches a flow path in the three-way electromagnetic valve V3 to a flow path in which the refrigerant is directed from the water/refrigerant heat exchanger 11 to the receiver 12 (see FIG. 1). Accordingly, the refrigerant circulating through the refrigerant system P1 is dissipated toward the hot water circulating through the hot water system P2 via the water/refrigerant heat exchanger 11 functioning as a condenser, and the hot water is heated. The vehicle cabin is warmed due to the heated hot water circulating through the hot water system P2 (the heater 15).

On the other hand, in the heating operation, the outdoor heat exchanger 13 functions as an evaporator. That is, the refrigerant circulating through the outdoor heat exchanger 13 absorbs heat from the outside air and is vaporized. When the heating operation continues in an environment in which the outside air temperature is low, the surface of the outdoor heat exchanger 13 is cooled below a freezing point due to heat absorption by the refrigerant, and becomes frosted. Then, the refrigerant flowing through the outdoor heat exchanger 13 cannot sufficiently absorb the heat from the outside air.

The defrosting operation control unit 21 of the control unit 2 determines whether or not the outflow refrigerant temperature of the outdoor heat exchanger 13 has become equal to or lower than a defrosting condition threshold value Tth1 during the heating operation (step S01). It should be noted that the defrosting condition threshold value Tth1 is defined, for example, as “outside air temperature −5° C.” (it is assumed that a temperature sensor capable of detecting an outside air temperature is separately mounted in the vehicle).

When the outflow refrigerant temperature of the outdoor heat exchanger 13 exceeds the defrosting condition threshold value Tth1 during the heating operation (step S01: NO), the defrosting operation control unit 21 does not start the defrosting operation, and the heating operation control unit 20 continues a normal heating operation.

When the outflow refrigerant temperature of the outdoor heat exchanger 13 has become equal to or lower than the defrosting condition threshold value Tth1 during the heating operation (step S01: YES), the defrosting operation control unit 21 starts the defrosting operation (step S02). That is, the defrosting operation control unit 21 determines that frost has been generated in the outdoor heat exchanger 13 on the basis of the outflow refrigerant temperature of the outdoor heat exchanger 13 being equal to or lower than the defrosting condition threshold value Tth1 (the temperature of the refrigerant has not sufficiently risen), and starts the defrosting operation.

When the defrosting operation control unit 21 starts the defrosting operation, the defrosting operation control unit 21 closes the two-way electromagnetic valve V1 and opens the two-way electromagnetic valve V2. Further, the defrosting operation control unit 21 switches the flow path in the three-way electromagnetic valve V3 to a flow path in which the refrigerant is directed from the water/refrigerant heat exchanger 11 to the outdoor heat exchanger 13 (see FIG. 1). Accordingly, the refrigerant (a high-temperature high-pressure refrigerant) discharged from the compressor 10 flows into the outdoor heat exchanger 13, and the outdoor heat exchanger 13 is heated. The frost attached to the surface of the outdoor heat exchanger 13 is melted by the defrosting operation.

On the other hand, in the defrosting operation, the evaporator 14 absorbs heat in the vehicle cabin. Therefore, an indoor temperature of the vehicle decreases (similar to the cooling operation).

The defrosting operation release instruction unit 22 determines whether or not the outflow refrigerant temperature of the outdoor heat exchanger 13 is equal to or higher than the defrosting release condition threshold value Tth2 during the defrosting operation (step S03). It should be noted that the defrosting release condition threshold value Tth2 is a value higher than the defrosting condition threshold value Tth1, and is defined as, for example, “10° C.” or “15° C.”.

When the outflow refrigerant temperature of the outdoor heat exchanger 13 is equal to or higher than the defrosting release condition threshold value Tth2 during the defrosting operation (step S03: YES), the defrosting operation release instruction unit 22 outputs a defrosting operation release instruction to the defrosting operation control unit 21. Accordingly, the defrosting operation of the defrosting operation control unit 21 is released (step S05).

That is, the defrosting operation release instruction unit 22 determines that the frost attached to the outdoor heat exchanger 13 has melted on the basis of the outflow refrigerant temperature of the outdoor heat exchanger 13 having become equal to or higher than the defrosting release condition threshold value Tth2 (the temperature of the refrigerant has sufficiently risen), and outputs a defrosting operation release instruction.

When the outflow refrigerant temperature of the outdoor heat exchanger 13 is lower than the defrosting release condition threshold value Tth2 during the defrosting operation (step S03: NO), the defrosting operation release instruction unit 22 further determines whether the defrosting release condition based on the position and speed of the vehicle is satisfied (step S04).

When the defrosting release condition based on the position and speed of the vehicle is not satisfied (step S04: NO), the defrosting operation release instruction unit 22 returns to step S03 without outputting the defrosting operation release instruction, and performs a determination process based on the outflow refrigerant temperature again.

On the other hand, when the defrosting release condition based on the position and speed of the vehicle is satisfied (step S04: YES), the defrosting operation release instruction unit 22 outputs the defrosting operation release instruction to the defrosting operation control unit 21. Accordingly, the defrosting operation of the defrosting operation control unit 21 is released (step S05). That is, when the defrosting release condition based on the position and speed of the vehicle is satisfied, the defrosting operation release instruction unit 22 outputs the defrosting operation release instruction even when the outflow refrigerant temperature is lower than the defrosting release condition threshold value Tth2.

Next, a determination process of the defrosting operation release instruction unit 22 in step S04 will be described in detail. Specifically, in the determination process in step S04, the defrosting operation release instruction unit 22 performs any one or a combination of two or more of three processes below.

### (1) Determination Process of Defrosting Operation Release Condition Based on Speed of Vehicle

In the determination process of step S04, the defrosting operation release instruction unit 22 executes the determination process illustrated in FIG. 4.

That is, the defrosting operation release instruction unit 22 acquires the traveling speed of the vehicle through the vehicle information acquisition unit 23 (FIG. 2), and determines whether or not the traveling speed is equal to or higher than a predetermined speed determination threshold value Vth (for example, “80 km/h”) (step S10).

When the traveling speed of the vehicle is lower than the speed determination threshold value Vth (step S10: NO), the defrosting operation release instruction unit 22 determines that the defrosting release condition is not satisfied (the defrosting operation is to be continued), and does not output the release instruction (step S11). That is, when the traveling speed of the vehicle is relatively low (lower than the speed determination threshold value Vth), it can be considered that a degree of degradation of the defrosting performance due to the traveling wind is also small. Therefore, it is possible to effectively perform removal of the frost attached to the outdoor heat exchanger 13 by performing the defrosting operation.

When the traveling speed of the vehicle is equal to or higher than the speed determination threshold value Vth (step S10: YES), the defrosting operation release instruction unit 22 then determines whether or not a predefined time (For example, “5 minutes”; hereinafter also described as a “certain time”) has elapsed in a state in which the traveling speed of the vehicle is equal to or higher than the speed determination threshold value Vth (step S12).

When a certain time has not elapsed in the state in which the traveling speed of the vehicle is equal to or higher than the speed determination threshold value Vth (step S12: NO), the defrosting operation release instruction unit 22 repeatedly performs the determination as to whether the traveling speed of the vehicle is equal to or higher than the speed determination threshold value Vth (step S10).

On the other hand, when a certain time has elapsed in the state in which the traveling speed of the vehicle is equal to or higher than the speed determination threshold value Vth (step S12: YES), the defrosting operation release instruction unit 22 determines that the defrosting release condition is satisfied (the defrosting operation is to be released) and outputs the release instruction (step S13). That is, when a state in which the traveling speed of the vehicle is relatively high (equal to or higher than the speed determination threshold value Vth) has continued for a predetermined time or more, it is assumed that the vehicle is in an operation situation in which the traveling speed will not decrease for a while (for example, while the vehicle is traveling on an expressway or an arterial highway). Accordingly, even when the defrosting operation is performed, an effect thereof cannot be sufficiently obtained, and it is assumed that it will take a long time to satisfy the defrosting release condition (until the outflow refrigerant temperature has become equal to or higher than the defrosting release condition threshold value Tth2). Therefore, in order to prevent the heating operation from being not resumed for a long time, the defrosting operation release instruction unit 22 outputs a release instruction to release the defrosting operation even when the outflow refrigerant temperature of the outdoor heat exchanger 13 has not increased to the defrosting release condition threshold value Tth2.

Here, the outflow refrigerant temperature of the outdoor heat exchanger 13 is rising to some extent due to the defrosting operation before the above release instruction is output (even though the outflow refrigerant temperature has not reached the defrosting release condition threshold value Tth2). Therefore, the vehicular air conditioning system 1 can perform the heating operation even after the defrosting operation has been released through step S13.

(2) Determination Process for Defrosting Operation Release Condition Based on Road on which Vehicle Travels

In the determination process of step S04, the defrosting operation release instruction unit 22 executes a determination process illustrated in FIG. 5.

That is, the defrosting operation release instruction unit 22 acquires a traveling position of the vehicle through the vehicle information acquisition unit 23 (FIG. 2), collates the traveling position with map information, and determines whether or not the vehicle has entered a predesignated expressway (step S20).

When the vehicle has not entered the predesignated expressway (step S20: NO), the defrosting operation release instruction unit 22 determines that the defrosting release condition is not satisfied (the defrosting operation is to continue), and does not output the release instruction (step S21). That is, when the vehicle is not traveling on an expressway, it can be considered that the degree of degradation of the defrosting performance due to the traveling wind is small. Therefore, it is possible to effectively perform removal of the frost attached to the outdoor heat exchanger 13 by performing the defrosting operation.

On the other hand, when the vehicle has entered the predesignated expressway (step S20: YES), the defrosting operation release instruction unit 22 determines that the defrosting release condition is satisfied (the defrosting operation is to be released), and outputs the release instruction (step S22). That is, when the vehicle has entered an expressway, it is assumed that the vehicle will continue to travel at high speed for a while. Accordingly, even when the defrosting operation is performed, an effect thereof cannot be sufficiently obtained, and it is assumed that it will take a long time to satisfy the defrosting release condition (until the outflow refrigerant temperature has become equal to or higher than the defrosting release condition threshold value Tth2). Therefore, in order to prevent the heating operation from being not resumed for a long time, the defrosting operation release instruction unit 22 outputs a release instruction to release the defrosting operation even when the outflow refrigerant temperature of the outdoor heat exchanger 13 does not increase to the defrosting release condition threshold value Tth2.

### (3) Determination Process of Defrosting Operation Release Condition Based on Destination of Occupant

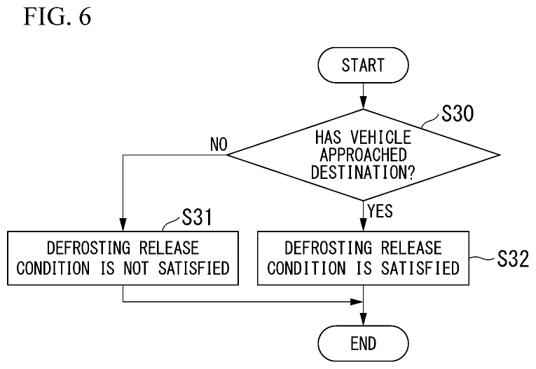

In the determination process of step S04, the defrosting operation release instruction unit 22 executes a determination process illustrated in FIG. 6.

That is, the defrosting operation release instruction unit 22 first acquires position information indicating the destination of the occupant through the destination information acquisition unit 24 (FIG. 2). Then, the defrosting operation release instruction unit 22 acquires the traveling position of the vehicle through the vehicle information acquisition unit 23 (FIG. 2). When a distance from the destination to the current position of the vehicle has become equal to or smaller than a predetermined determination threshold value (for example, “5 km”), the defrosting operation release instruction unit 22 determines that the defrosting release condition is satisfied (the defrosting operation is to be released) and outputs a release instruction. That is, when the vehicle has approached the destination, it is assumed that a time from that point in time to a point in time of reaching the destination is short. Even when the defrosting operation continues in such a situation, the vehicle is highly likely to stop before the heating operation is resumed. That is, in order to ensure high heating performance after a predetermined time has elapsed (after the defrosting operation is released), a significance of continuing to perform the defrosting operation is extremely small at a current point in time. Therefore, in order to prevent the vehicle from reaching the destination while the heating operation is not resumed, the defrosting operation release instruction unit 22 outputs the release instruction to release the defrosting operation even when the outflow refrigerant temperature of the outdoor heat exchanger 13 has not risen to the defrosting release condition threshold value Tth2.

It should be noted that it is assumed that the process flow from step S01 to step S05 illustrated in FIG. 3 is repeatedly executed even after the defrosting operation is released by the defrosting operation release instruction unit 22 and the heating operation is resumed by the heating operation control unit 20.

### (Operation and Effects)

As described above, the control unit 2 of the vehicular air conditioning system 1 according to the first embodiment includes the defrosting operation control unit 21 that performs the defrosting operation in the refrigerant system P1 when an outflow refrigerant temperature of the outdoor heat exchanger 13 in the refrigerant system P1 becomes equal to or lower than the defrosting condition threshold value Tth1, the defrosting operation release instruction unit 22 that outputs a defrosting operation release instruction when the outflow refrigerant temperature has become equal to or higher than the defrosting release condition threshold value Tth2, and the vehicle information acquisition unit 23 that acquires at least one of the position and the speed of the vehicle in which the vehicular air conditioning system 1 is mounted. Further, the defrosting operation release instruction unit 22 further outputs a defrosting operation release instruction even when the outflow refrigerant temperature is lower than the defrosting release condition threshold value Tth2 in a case in which at least one of the position and the speed of the vehicle satisfies the predefined condition.

Thus, it is possible to prevent the defrosting operation from continuing for a long time in an environment in which sufficient defrosting performance cannot be obtained, and a time in which the heating operation cannot be used from increasing.

### Second Embodiment

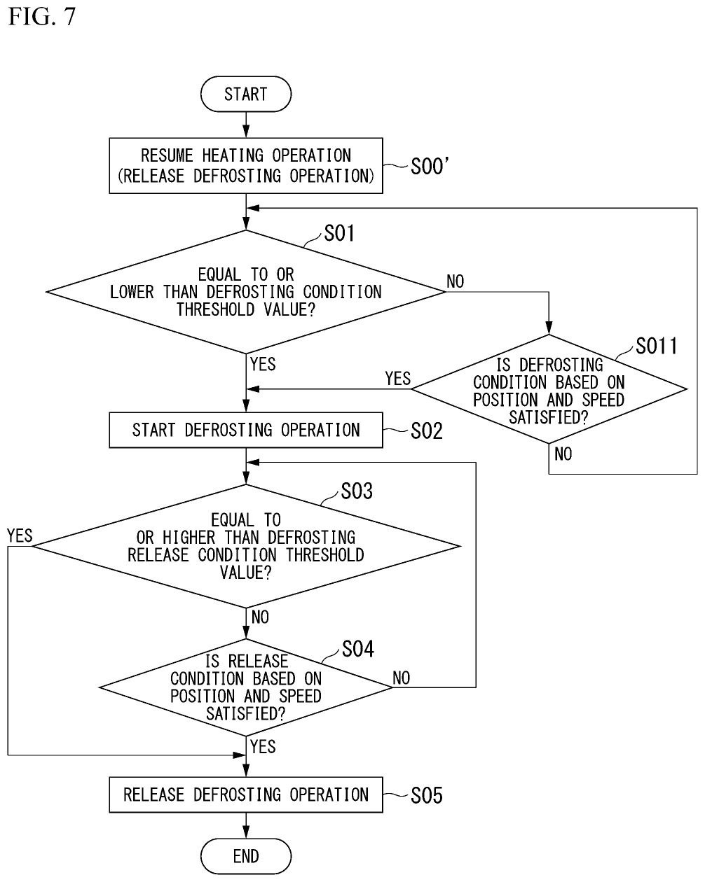

Next, a vehicular air conditioning system according to a second embodiment will be described with reference to FIG. 7.

### (Process Flow of Control Unit)

FIG. 7 is a diagram illustrating a process flow of the control unit according to the second embodiment.

It should be noted that an overall configuration and functional configuration of the vehicular air conditioning system 1 according to the second embodiment are the same as those in the first embodiment (FIGS. 1 and 2), and therefore illustration thereof will be omitted.

In the embodiment, the process flow illustrated in FIG. 7 is started, for example, from a point in time when the defrosting operation is released and the heating operation of the heating operation control unit 20 is resumed.

As illustrated in FIG. 7, when the defrosting operation is released, the heating operation control unit 20 of the control unit 2 resumes the heating operation (step S00′).

When an outflow refrigerant temperature of an outdoor heat exchanger 13 has become equal to or lower than a defrosting condition threshold value Tth1 during the heating operation (step S01: YES), the defrosting operation control unit 21 starts a defrosting operation (step S02).

When the outflow refrigerant temperature of the outdoor heat exchanger 13 exceeds the defrosting condition threshold value Tth1 during the heating operation (step S01: NO), the defrosting operation control unit 21 further determines whether or not a defrosting condition based on a position and speed of a vehicle is satisfied (step S011).

When the defrosting condition based on the position and speed of the vehicle is not satisfied (step S011: NO), the defrosting operation control unit 21 returns to step S01 without starting a defrosting operation, and performs a determination process based on the outflow refrigerant temperature again.

On the other hand, when the defrosting condition based on the position and speed of the vehicle is satisfied (step S011: YES), the defrosting operation control unit 21 starts the defrosting operation (step S02). That is, when the defrosting condition based on the position and speed of the vehicle is satisfied, the defrosting operation control unit 21 starts the defrosting operation even when the outflow refrigerant temperature exceeds the defrosting condition threshold value Tth1.

Next, the determination process of the defrosting operation control unit 21 in step S011 will be described. Specifically, in step S011, the defrosting operation control unit 21 performs any one or a combination of processes below.

That is, in step S011, when the traveling speed of the vehicle becomes smaller than the speed determination threshold value Vth and the outflow refrigerant temperature of the outdoor heat exchanger 13 is lower than the defrosting release condition threshold value Tth2, the defrosting operation control unit 21 starts the defrosting operation even when the outflow refrigerant temperature exceeds the defrosting condition threshold value Tth1. That is, when the traveling speed of the vehicle once becomes low (lower than the speed determination threshold value Vth), it is assumed that high-speed traveling driving is ended and a chance to obtain sufficient defrosting performance is increased in future. Therefore, when the defrosting operation has been released before the outflow refrigerant temperature rises to the defrosting release condition threshold value Tth2, the defrosting operation sufficiently continues to the end (until the frost is completely removed) by resuming the defrosting operation.

Further, when it is determined in step S011 that the vehicle has left the expressway and the outflow refrigerant temperature of the outdoor heat exchanger 13 is lower than the defrosting release condition threshold value Tth2, the defrosting operation control unit 21 starts the defrosting operation even when the outflow refrigerant temperature exceeds the defrosting condition threshold value Tth1. That is, when the vehicle has left the expressway, it is assumed that the traveling speed of the vehicle decreases and a chance of obtaining sufficient defrosting performance increases. Therefore, when the defrosting operation has been released before the outflow refrigerant temperature rises to the defrosting release condition threshold value Tth2, the defrosting operation sufficiently continues to the end by resuming the defrosting operation.

In FIG. 7, since a process after step S03 is the same as that in the first embodiment, description thereof will be omitted.

### OTHER EMBODIMENTS

The vehicular air conditioning systems 1 according to the first and second embodiments have been described above in detail, but a specific aspect of the vehicular air conditioning system 1 is not limited thereto, and various design changes and the like can be made without departing from a gist.

For example, the case in which the control unit 2 (the defrosting operation release instruction unit 22) according to the first embodiment outputs the release instruction when at least one of the case in which “the vehicle has enters the expressway” and the case in which “the distance from the vehicle to the destination is equal to or smaller than the predetermined determination threshold value” occurs has been described, but the other embodiments are not limited to this aspect. That is, an aspect in which the defrosting operation release instruction unit 22 outputs the release instruction when the vehicle enters any one of predefined areas may be adopted.

Further, the case in which the defrosting operation control unit 21 performs the determination processes of step S01 to step S011 of the process flow (FIG. 7) on the premise that the control unit 2 according to the second embodiment includes the defrosting operation release instruction unit 22 described in the first embodiment has been described. However, another embodiment is not limited to this aspect.

For example, an aspect in which the control unit 2 according to the other embodiment does not include the defrosting operation release instruction unit 22 may be adopted. That is, an aspect in which the control unit 2 according to the other embodiment has only a function of “performing the defrosting operation even when the outflow refrigerant temperature exceeds the defrosting condition threshold value Tth1 in a case in which at least one of the position and the speed of the vehicle satisfies the predefined condition” may be adopted.

Further, in each of the above-described embodiments, steps of various processes of the vehicular air conditioning system 1 (the control unit 2) described above are stored in a format of a program in a computer-readable recording medium, and the various processes are performed by a computer reading and executing this program. Further, the computer-readable recording medium refers to a magnetic disk, a magneto-optical disk, a CD-ROM, a DVD-ROM, a semiconductor memory, or the like. Further, this computer program may be distributed to a computer through a communication line, and the computer that has received this distribution may execute the program.

The program may be a program for realizing some of the above-described functions. Further, the program may be a so-called difference file (difference program) that can realize the above-described functions in combination with a program already recorded in a computer system. Further, the vehicular air conditioning system 1 (the control unit 2) may be configured using one computer or may be configured using a plurality of communicatively connected computers.

While some embodiments of the present invention have been described, these embodiments have been presented by way of example and are not intended to limit the scope of the invention. These embodiments can be implemented in various other forms, and various omissions, replacements, and changes can be made without departing from the gist of the invention. These embodiments or modifications thereof are included in the inventions described in the claims and equivalents thereof as the embodiments or modifications are included in the scope or the gist of the invention.

### INDUSTRIAL APPLICABILITY

With the control device, the vehicular air conditioning system, the method for controlling a vehicular air conditioning system, and the program described above, it is possible to prevent the defrosting operation from continuing for a long time.

### REFERENCE SIGNS LIST

1 Vehicular air conditioning system
10 Compressor
11 Water/refrigerant heat exchanger
12 Receivers
13 Outdoor heat exchanger
14 Evaporator
15 Heater
16 Air mix damper
160 Return duct damper
17 Water pump
18 Engine
19 Radiator
2 Control unit (control device)
20 Heating operation control unit
21 Defrosting operation control unit
22 Defrosting operation release instruction unit
23 Vehicle information acquisition unit
24 Destination information acquisition unit
V1, V2 Two-way electromagnetic valve
V3 Three-way electromagnetic valve
V4 Four-way valve
V5 Check valve
E1, E2 Expansion valve
T1, T2 Refrigerant temperature sensor
P1 Refrigerant system
P2 Hot water system
P3 Engine coolant system
U Indoor unit

1. A control device configured to control a vehicular air conditioning system comprising:
a defrosting operation control unit configured to perform a defrosting operation in a refrigerant system when an outflow refrigerant temperature of an outdoor heat exchanger that is one of heat exchangers in the refrigerant system and is disposed outside has become equal to or lower than a defrosting condition threshold value;
a defrosting operation release instruction unit configured to output a defrosting operation release instruction when the outflow refrigerant temperature has become equal to or higher than a defrosting release condition threshold value; and
a vehicle information acquisition unit configured to acquire at least one of a position and a speed of a vehicle in which the vehicular air conditioning system is mounted,
wherein the defrosting operation release instruction unit is configured to perform a determination as to whether or not the outflow refrigerant temperature is equal to or higher than the defrosting release condition threshold value during the defrosting operation, and a determination as to whether or not at least one of the position and the speed of the vehicle satisfies a predefined condition during the defrosting operation, and output the defrosting operation release instruction even when the outflow refrigerant temperature is lower than the defrosting release condition threshold value in a case in which at least one of the position and the speed of the vehicle satisfies a predefined condition.

2. The control device according to claim 1, wherein the defrosting operation release instruction unit is configured to output the release instruction when a time during which the speed of the vehicle is equal to or higher than a predetermined speed determination threshold value has continued for a predetermined time or more.

3. The control device according to claim 1, wherein the defrosting operation release instruction unit is configured to output the release instruction when the vehicle enters a predefined area.

4. The control device according to claim 3, wherein the defrosting operation release instruction unit is configured to output the release instruction when the vehicle has entered an expressway.

5. The control device according to claim 3, further comprising:
a destination information acquisition unit configured to acquire information indicating a destination of an occupant,
wherein the defrosting operation release instruction unit is configured to output the release instruction when a distance from the vehicle to the destination has become equal to or smaller than a predetermined determination threshold value.

6. The control device according to claim 1, wherein the defrosting operation control unit is configured to further perform the defrosting operation even when the outflow refrigerant temperature exceeds the defrosting condition threshold value in a case in which at least one of the position and the speed of the vehicle satisfies a predefined condition.

7. A control device configured to control a vehicular air conditioning system comprising:
a defrosting operation control unit configured to perform a defrosting operation in a refrigerant system when an outflow refrigerant temperature of an outdoor heat exchanger that is one of heat exchangers in the refrigerant system and is disposed outside has become equal to or lower than a defrosting condition threshold value; and
a vehicle information acquisition unit configured to acquire at least one of a position and a speed of a vehicle in which the vehicular air conditioning system is mounted,
wherein the defrosting operation control unit is configured to perform a determination as to whether or not the outflow refrigerant temperature is equal to or lower than the defrosting condition threshold value during the defrosting operation is released, and a determination as to whether or not at least one of the position and the speed of the vehicle satisfies a predefined condition during the defrosting operation is released, and perform the defrosting operation even when the outflow refrigerant temperature exceeds the defrosting condition threshold value in a case in which at least one of the position and the speed of the vehicle satisfies a predefined condition.

8. A vehicular air conditioning system comprising:
the control device according to claim 1; and
the refrigerant system.

9. A method for controlling a vehicular air conditioning system comprising:
a defrosting operation control step of performing a defrosting operation in a refrigerant system when an outflow refrigerant temperature of an outdoor heat exchanger that is one of heat exchangers in the refrigerant system and is disposed outside has become equal to or lower than a defrosting condition threshold value;
a defrosting operation release instruction step of outputting a defrosting operation release instruction when the outflow refrigerant temperature has become equal to or higher than a defrosting release condition threshold value; and
a vehicle information acquisition step of acquiring at least one of a position and a speed of a vehicle in which the vehicular air conditioning system is mounted,
wherein the defrosting operation release instruction step includes a step of performing a determination as to whether or not the outflow refrigerant temperature is equal to or higher than the defrosting release condition threshold value during the defrosting operation, and a determination as to whether or not at least one of the position and the speed of the vehicle satisfies a predefined condition during the defrosting operation, and outputting a defrosting operation release instruction even when the outflow refrigerant temperature is lower than the defrosting release condition threshold value in a case in which at least one of the position and the speed of the vehicle satisfies a predefined condition.

10. A non-transitory computer-readable medium that stores a program causing a computer configured to control a vehicular air conditioning system to function as:
a defrosting operation control unit configured to perform a defrosting operation in a refrigerant system when an outflow refrigerant temperature of an outdoor heat exchanger that is one of heat exchangers in the refrigerant system and is disposed outside has become equal to or lower than a defrosting condition threshold value;
a defrosting operation release instruction unit configured to output a defrosting operation release instruction when the outflow refrigerant temperature has become equal to or higher than a defrosting release condition threshold value; and
a vehicle information acquisition unit configured to acquire at least one of a position and a speed of a vehicle in which the vehicular air conditioning system is mounted,
wherein the defrosting operation release instruction unit is configured to perform a determination as to whether or not the outflow refrigerant temperature is equal to or higher than the defrosting release condition threshold value during the defrosting operation, and a determination as to whether or not at least one of the position and the speed of the vehicle satisfies a predefined condition during the defrosting operation, and output the defrosting operation release instruction even when the outflow refrigerant temperature is lower than the defrosting release condition threshold value in a case in which at least one of the position and the speed of the vehicle satisfies a predefined condition.
